(19) United States
(12) Patent Application Publication
(10) Pub. No.: US 2011/0071867 A1
(43) Pub. Date: Mar. 24, 2011

(54) TRANSFORMATION OF DATA CENTERS TO MANAGE POLLUTION

(75) Inventors: Shyh-Kwei Chen, Hawthorne, NY (US); Parijat Dube, Hawthorne, NY (US); Shyam S. Gonella, East Windsor, NJ (US); Genady Grabarnik, Scarsdale, NY (US); Juhnyoung Lee, Hawthorne, NY (US); Jih-Shyr Yih, Hawthorne, NY (US)

(73) Assignee: INTERNATIONAL BUSINESS MACHINES CORPORATION, Armonk, NY (US)

(21) Appl. No.: 12/565,349

(22) Filed: Sep. 23, 2009

(51) Int. Cl. G06Q 10/00; G06Q 50/00; G06F 19/00

(52) U.S. Cl. 705/7; 702/22

(57) ABSTRACT

A system and method for identifying green transformation initiatives for an organization use data for analysis, the data including at least one or more industry practice values associated with metrics for determining pollutions from greenhouse gases and organization's values associated with the metrics. One or more components in the organization producing the organization's values that are worse than the industry practice values are identified at least based on the analysis. One or more transformation initiatives are discovered, for instance, using daisy chain analysis technique, for transforming the identified one or more components to at least meet the industry practice values. Benefits associated with the one or more transformation initiatives may be also determined using a calculator module. The one or more components may be transformed by implementing the one or more transformation initiatives.

### BACKGROUND

The present disclosure relates generally to green transformation and managing emission of greenhouse gases such as carbon dioxide and/or the like into the atmosphere, and more specifically to a computer tool or a software tool for facilitating management of greenhouse gas such as carbon emission and realizing emission targets in infrastructures such as Information Technology (IT) systems and data centers.

Atmospheric warming is a now a broadly accepted trend. Global greenhouse gas emissions, for example, carbon dioxide (CO2) concentration levels, are rising faster than expected. Many companies and enterprises are now turning their focus to energy and environmental costs such as CO2 emissions. Major investors increasingly see poor green performance as a source of risk in their investments.

Some of data centers' greenhouse gas emissions originate from data center electricity consumption, and it is expected that the demand for data center energy and thus data center electricity consumption is likely to increase. Current data center practice is characterized by poor energy efficiency, for example, caused by poor demand/capacity planning and operation across functions, such as business, IT, facilities, and poor asset management. Lack of methods, models and tools for diagnostics and analysis further contributes to the poor energy efficiency in current data center practices. For example, difficulty in understanding current state of carbon emission, difficulty in identifying and analyzing opportunities for reduction, and difficulty in making optimal decisions to realize goals, all add up to poor energy efficiency.

### BRIEF SUMMARY OF THE INVENTION

A method and system for identifying green transformation initiatives for an organization are provided. The method, in one aspect, may include receiving data for analysis, the data including at least one or more industry practice values associated with metrics for determining pollutions from greenhouse gases and organization's values associated with the metrics. The method may also include identifying one or more components in the organization producing the organization's values that are worse than the industry practice values at least based on the received data for analysis, and discovering one or more transformation initiatives for transforming the identified one or more components to at least meet the industry practice values. The method may further include determining benefits associated with the one or more transformation initiatives. The steps of identifying, discovering and determining may be performed using a component business model workbench. The method may also include transforming the one or more components by implementing the one or more transformation initiatives.

A system for identifying green transformation initiatives for an organization, in one aspect, may include a green diagnosis processing module operable to receive data for analysis, the data including at least one or more industry practice values associated with metrics for determining pollutions from greenhouse gases and organization's values associated with the metrics, the green diagnosis processing module further operable to identify one or more components in the organization producing the organization's values that are worse than the industry practice values at least based on the received data for analysis. The system may also include a green solution discovery processing module operable to discover one or more transformation initiatives for transforming the identified one or more components to at least meet the industry practice values. The system may further include a green cases analysis module operable to perform carbon benefit and cost analysis associated with the discovered one or more transformation initiatives.

A program storage device readable by a machine, tangibly embodying a program of instructions executable by the machine to perform methods disclosed herein may be also provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1A is an architectural diagram illustrating components of a green transformation system of the present disclosure in one embodiment.

FIG. 1B is a component diagram illustrating functional components of the present disclosure in another embodiment.

FIG. 2 illustrates an overview of a green transformation methodology of the present disclosure in one embodiment.

FIG. 3 illustrates the features of a business case calculator in one embodiment.

FIG. 4 illustrates an example of daisy-chain of models.

FIG. 5 illustrates an example of a data model that includes daisy chain of data.

FIG. 6 shows an example of organization overlay.

FIG. 7 illustrates an example of solution analysis result.

FIG. 8 illustrates an example of consolidated financial and carbon analysis, cash and carbon flow forecast.

FIG. 9 is an example of a snapshot of benefit calculations.

### DETAILED DESCRIPTION

Component Business Model (CBM) based green transformation methodology is provided for data centers to automatically identify “hotspots” and “shortfall” areas for carbon reduction in as-is or current data center practice, to automatically identify solutions, and to analyze costs and benefits of the solutions and prioritize them. In one aspect, a green diagnosis system component is provided to identify hotspots of carbon reduction in the as-is enterprise IT management practice and for assessing the as-is practice to identify and categorize shortfall areas for carbon reduction.

In one aspect, a green solution discovery system component may be provided for automatically identifying and composing solutions of the identified “hotspots” and “shortfalls”, for instance, by using the daisy-chain analysis. The daisy-chain analysis includes inferencing methodology.

In another aspect, a green case analysis model for an organization is provided for assessing cost and carbon benefit, resolving and optimizing investment and profit, and prioritizing initiatives. Identified solutions may be prioritized based on a combined set of options, and adding green dimensions such as green solution investment, carbon trading, and others.

The following terminologies are referred to in the present disclosure.

Data centers: Facility used to house computer systems and associated components such as but not limited to, telecommunications and storage systems, redundant or backup power supplies, redundant data communications connections, environmental controls, e.g., air conditioning, fire suppression, special security devices.

Carbon footprint: A measure of the impact human activities have on the environment in terms of the amount of greenhouse gases produced, for example, measured in units of carbon dioxide. An individual's carbon footprint may be viewed as the total amount of greenhouse gases such as carbon dioxide attributable to the actions of the individual (for example, mainly through their energy use) over a period of one year.

Life cycle of carbon footprint: all-encompassing and include all possible causes for greenhouse gas emission such as carbon emission.

Carbon offsets: A tool used for mitigating carbon emissions through development of alternative projects such as solar or wind energy or reforestation or others.

Direct emissions: emission whose source is on-site or internal. The sources of carbon emission may be categorized, for example, internal (e.g. source is organization ecosystem) or external (e.g., source is supply/distribution chain).

Indirect emissions: emission whose source is off-site or external; upstream refers to emissions related to distribution and customer chain, downstream refers to emissions related supply chain and/or material providers.

Carbon Emission Trading: An approach to controlling pollution by providing economic incentives for achieving reductions in the emissions of pollutants, sometimes called “cap and trade”. A central authority (usually a government or international body) sets a limit or cap on the amount of a pollutant that can be emitted. Companies or other groups are issued emission permits and are required to hold an equivalent number of allowances (or credits) which represent the right to emit a specific amount. The total amount of allowances and credits cannot exceed the cap, limiting total emissions to that level. Companies that need to increase their emissions must buy credits from those who pollute less. The transfer of allowances is referred to as a trade. In effect, the buyer is paying a charge for polluting, while the seller is being rewarded for having reduced emissions by more than was needed.

Component Business Modeling (CBM): A modeling and transformation technique for components of an organization, which the users, for example, consulting industry, utilize to understand and transform organizations. CBM can represent the entire organization in a simple framework that fits on a single page, evolution of traditional views of an organization, such as views of organization units, functions, geography, processes or workflow. CBM can also help to identify basic building blocks of an organization, where each building block includes the people, processes and technology needed by this component to act as a standalone entity and deliver value to the organization.

In one aspect, the present disclosure provides a holistic extension to a transformation method and system to incorporate green dimension. The methodologies and functional components or systems described herein may be implemented and provided as a framework or development environment, also referred to as a workbench, i.e., the Green Transformation Workbench (GTW). The workbench may include various functional components or modules as well as user interface programs for interacting with the users and receiving data inputs and providing outputs to the user in providing green transformation.

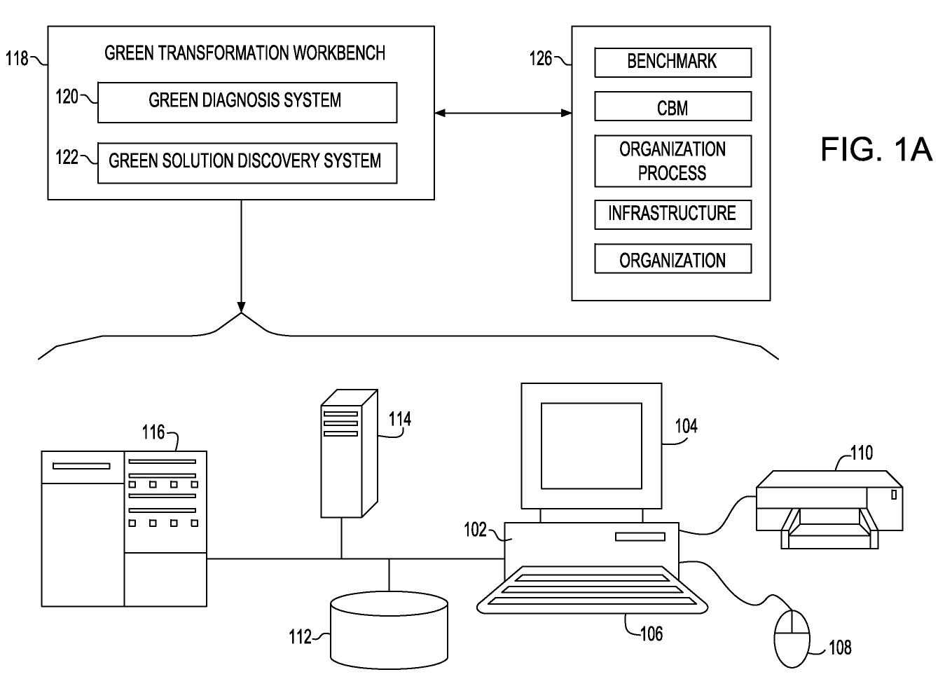

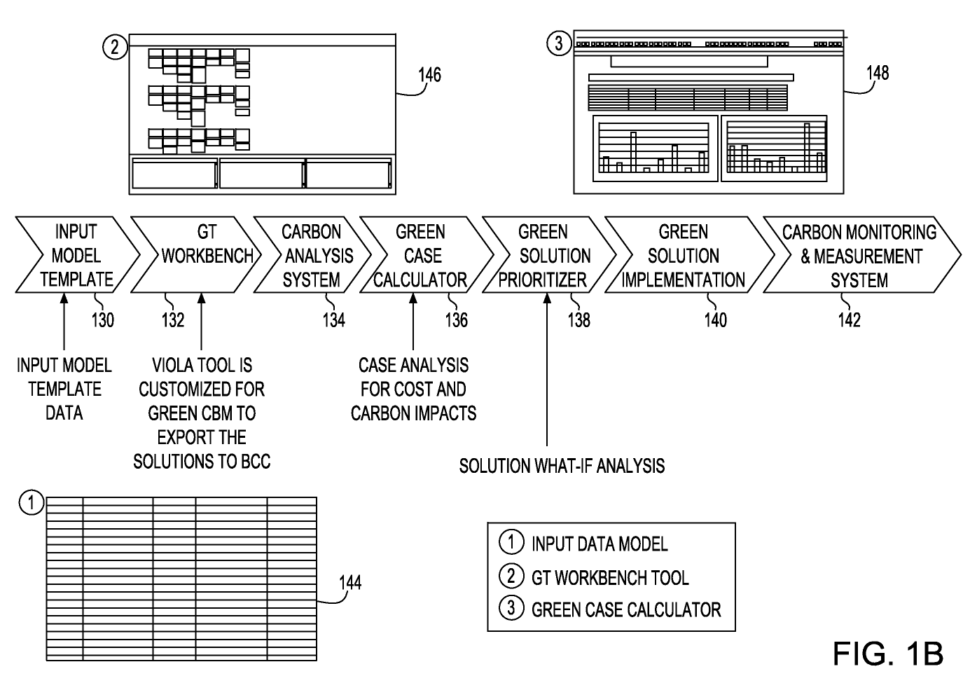

FIG. 1A is an architectural diagram illustrating components of a green transformation system of the present disclosure in one embodiment. The systems and methodologies of the present disclosure, e.g., the GTW, may be carried out or executed in a computer system 102 that includes a processing unit, which houses one or more processors and/or cores, memory and other systems components (not shown expressly in the drawing) that implement a computer processing system, or computer that may execute a computer program product. The computer program product may comprise media, for example a hard disk, a compact storage medium such as a compact disc, or other storage devices, which may be read by the processing unit by any techniques known or will be known to the skilled artisan for providing the computer program product to the processing system for execution.

The computer processing system that carries out the system and method of the present disclosure may also include a display device such as a monitor or display screen 104 for presenting output displays and providing a display through which the user may input data and interact with the processing system, for instance, in cooperation with input devices such as the keyboard 106 and mouse device 108 or pointing device. The computer processing system may be also connected or coupled to one or more peripheral devices such as the printer 110, scanner (not shown), speaker, and any other devices, directly or via remote connections. The computer processing system may be connected or coupled to one or more other processing systems such as a server 110, other remote computer processing system 114, network storage devices 112, via any one or more of a local Ethernet, WAN connection, Internet, etc. or via any other networking methodologies that connect different computing systems and allow them to communicate with one another. The various functionalities and modules of the systems and methods of the present disclosure may be implemented or carried out distributedly on different processing systems (e.g., 102, 114, 116), or on any single platform, for instance, accessing data stored locally or distributedly on the network.

Green Transformation Workbench (GTW) 118 provides an integrated view of various models and data 126, including a CBM, an organization process model (e.g., American Product Quality Council (APQC) Process Classification Framework and SAP Business Process Hierarchy), a value driver model, an infrastructure map, an organization structure map, and a solution catalog, with the models linked each other. The workbench helps organizations understand and transform in areas such as processes, infrastructure, and organizations.

GTW 118 helps understand the efficiency of operations with processes and infrastructure designed to maximize energy efficiency while meeting organizational needs. The infrastructure of a company, such as data center systems, buildings, factories, trucks, etc., is a major consumer of energy. GTW 118 helps organizations visualize how the infrastructure should deliver power efficiency and optimize operations by leveraging consolidation and virtualization.

GTW 118 automates the traditional component business model-based analyses by using visual queries and inferences. The qualitative analyses using the visual queries and inferences in the tool are generally referred to as daisy chain analysis. An example of the daisy chain analysis in the workbench is the ‘heat map’ analysis where it automatically discovers underperforming components in the map and color them based their performance. “Hotspots” refer to underperforming components or functions. The daisy chain analysis identifies the metrics associated with each component, compare their as-is values against the industry benchmark values. Underperforming components are ones associated with metrics whose as-is value is worse than the benchmark value. Another example of the daisy chain analysis is the ‘shortfall assessment’ of infrastructure and organization. The workbench infers and associates infrastructure systems and organizations with each component, and renders them in a component map. Then the user can visually identify and categorize shortfalls (or transformation opportunities) in infrastructure and organizations such as ‘gap,’ ‘deficiency,’ ‘duplication,’ and ‘over-extension.’ possible IT shortfalls into several types. A gap, for example, may indicate that a component does not have any support. The organization may want to consider an IT/organizational investment to improve the greenhouse gas or carbon or the like emission efficiency. A duplication may indicate that a component may have duplicate or multiple supports. The organization may want to consolidate the supports to improve emissions efficiency and maintenance overhead. A deficiency may indicate a lack of key functionality, or poorly designed functionality. An over-extension may indicate that a system designed to support one component is extended beyond its core capability to support others. Different definitions for the shortfall types may apply. The Green diagnosis system 120, for instance, may implement the daisy chain analysis functionalities for heat map analysis and shortfall assessment. Once the transformation opportunities are identified, the tool 118 also discovers solutions that may address the shortfalls by using the similar daisy chain analysis. The Green solution discovery system 122, for instance, may provide the functionalities for solution discovery.

In the method and system of the present disclosure, greenness and carbon aspects are associated with the CBM methodology by associating green and/or carbon metrics with the CBM components. For example, the heat map analysis compares the as-is value against the benchmark value of carbon metrics (such as the amount of carbon or the amount of electricity consumption). For example, to assess the “temperature” of a component, “Change Implementation”, we associate the component with a certain set of processes and/or activities and further with a certain set of green metrics. Then we compare the as-is value against the benchmark value to measure the temperature. The shortfall assessment may include qualitative analysis.

Once one or more transformation solutions for IT and/or organization are discovered, GTW 118 also provides a quantitative analysis on them, e.g., the case analysis in terms of standard financial metrics such as NPV (Net Present value), IRR (Internal Return Rate), ROI (Return on Investment), and Payback time. The workbench provides carbon benefit analyses for each solution category by using green metrics such as Internal Cost of Carbon per ton and percentage reduction in carbon. The workbench may provide normative and constructive performance analysis models, so it can be easily configured for different types of clients, initiatives, and projects. GT Workbench 118 capabilities can enable organizations to visualize, control and automate the infrastructure to deliver new levels of power efficiency and to optimize operations by leveraging consolidation and virtualization. GTW 118 in one aspect provides “Smart” consolidation, virtualization and optimization; integrates management of IT and facility equipment; efficiently compresses information to reduce storage requirements; models energy usage by asset and location; and monitors energy usage against thresholds.

FIG. 1B is a diagram illustrating functional components or modules of the present disclosure in one embodiment. In this embodiment, GT Workbench 132 and Green Case Calculator 136 facilitate the Green Transformation. An input model template sheet 130 provides GT Workbench 132 with the component map and underlying elements—processes, people, infrastructure, solutions, mapping. An input model template 130 including data collected, for example, in Excel™ Spreadsheet, is used by a workbench tool 132 to perform heat map analysis and shortfall assessments and solution identification using CBM. An example of the model template 144 may be a spreadsheet with data populated in it. A tool such as Viola™ may be customized to perform such functionalities. GT Workbench (GTW) 132 allows the qualitative analysis to identify pain points and inter-link with solutions for improvement. An example of a GTW view for allowing a user to perform the qualitative analysis such as the heat map analysis, shortfall assessment, and solution identification is shown at 146.

The Carbon Analysis system 134, for example, performs various functions such as quantifying and documenting green impact on the environment. An example of the carbon analysis system 134 is GreenCert. GreenCert, a solution developed by Enterprise Information Management (EIM), an IBM business partner, provides science-based tools to quantify, verify, document and market the atmospheric impact of greenhouse gashouse emissions on the environment. The solution is built on an IBM Service Oriented Architecture solution. GreenCert uses information management software solution to help address the globe's climate problems. The GreenCert infrastructure is based on a Service Oriented Architecture (SOA) that runs on a platform supported by IBM technologies—WebSphere Portal Enable, WebSphere Process Server, WebSphere Dashboard FrameWork, DB2 Universal Database, DB2 Content Manager, DB2 Records Manager, Lotus Forms, Lotus Sametime and Lotus Quickr and IBM System x servers. GreenCert can be deployed easily through power plants, factories or commercial buildings.

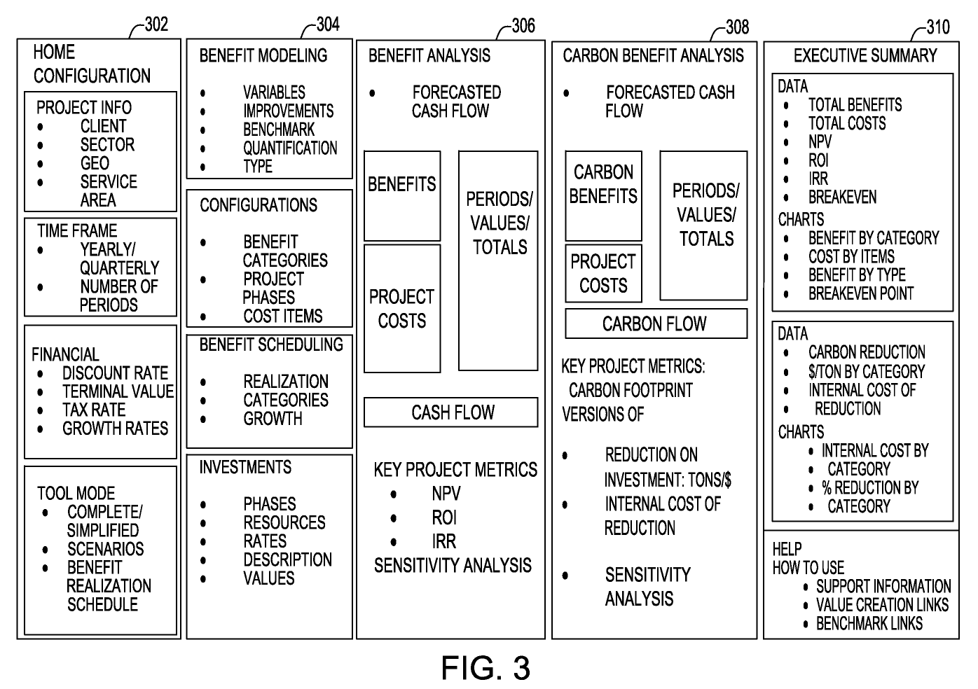

Green Case Calculator (GCC) 136 handles the quantitative aspect of chosen set of solutions providing financial and carbon metrics for decision support. The Green Case Calculator 136 performs case analysis for carbon benefit, costs and impact for the solution identified by the workbench 132. An example of a GCC view for allowing quantitative case analysis is shown at 148 and also in FIG. 3.

The Green Solution Prioritizer 138 prioritizes or ranks the identified solutions, for instance, using the data results from the Green Case Calculator 136 and performing what-if analysis. What-if analysis is sensitivity analysis that is the study of how the variation (uncertainty) in the output of a mathematical model can be apportioned, qualitatively or quantitatively, to different sources of variation in the input of a model; in this case of GTW, we calculate the carbon benefits of different sets of solutions identified. In one embodiment, we can then prioritize the solution in the order of the benefit amount, which becomes a possible roadmap of initiatives, or a justification of such a roadmap. The Green Solution Implementation module or functionality 140 provides plans for implementing the one or more solution in the IT infrastructure or system. A monitoring module or functionality 142 monitors and measures one or more factors such as heat flow, air flow, power consumption, temperature, and carbon emission, etc. The monitoring and measurement outputs may then be used again as an input in the input model template 130.

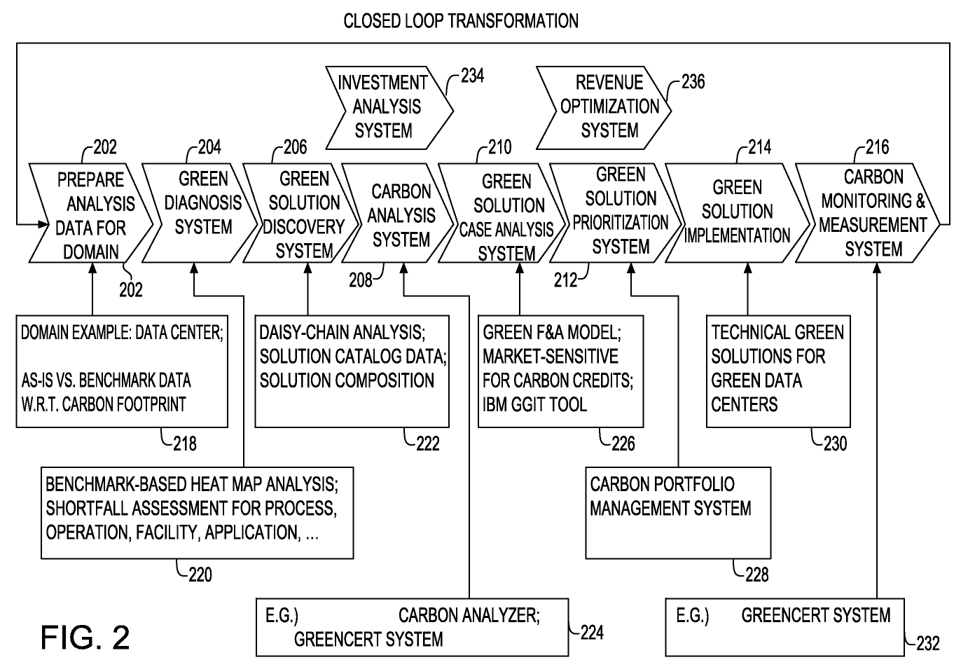

FIG. 2 illustrates an overview of a green transformation methodology of the present disclosure in one embodiment. The methodology broadly includes assessment, analysis, and prioritizing of transformation solutions. In one aspect, the initial diagnosis phase identifies the pain points in the components of an organization by comparing the as-is values on value drivers with the industry benchmark values from best practices. A pain point is an area where a company is noted to be underperforming in comparison to its peers or industry leaders or expectations set by the company. Pain points are identified, for example as explained above, through the association of component and/or processes to metrics and/or value drivers which measure the greenness and carbon emissions. The result can be used to help identify transformation opportunities in infrastructure and organizations with scope for improvement. A daisy-chain analysis helps in discovering the solutions to mitigate the pain points, which can be further analyzed for carbon-cost benefits by using the case modeler. The solutions, for example, are for improving greenness of services and/or IT systems, for improving data center cooling, improving infrastructure, electricity facility, planning, and others. By conducting benefit analyses iteratively with various combinations of solutions, the user can prioritize them for their significance and create a road map for final action.

At 202, preparation for data analysis takes place for a domain, establishing or identifying benchmarks including carbon footprint (or other greenhouse gases) benchmarks. A benchmark refers to an established standard, for example, for best practice in a given domain. It may be an average accepted value or agreed value associated with a given metric in a domain for best practice in that domain. The data may be collected from data center practitioners and also from literature. More examples of data are described in Data Center Energy Benchmarking Case Study, Lawrence Berkeley National Laboratory, February 2003. Shown at 218, an example of a domain is a data center and the data includes carbon footprint as-is and benchmark data. Preparing data includes picking or selecting a set of attributes indicative of domain specific green performance. Other examples of domain include IT, facility, infrastructure, organization, and available solutions. Data preparation may also include filtering and processing of measurement data and mapping it to domain specific benchmarks. Examples of metrics may include but are not limited to PUE and DCiE power consumption mapped to components. Data preparation may also include quantifying IT and non-IT to metrics that indicate the green efficiency of data centers. Data preparation methodology will be described in more detail below.

At 204, Green Diagnosis System functionality or module identifies enterprise hotspots that include carbon footprint and energy consumption operational metrics. “Hotspots” refer to underperforming components or functions. The Green Diagnosis System may utilize IBM's Component Business Model-based business transformation methodology that represents enterprises in a consolidated view, grouping together similar activities as a component and classifying a functionality into non-overlapping components. The Green Diagnosis System identifies processes and activities associated with each component. The Green Diagnosis System identifies and assesses shortfalls and gaps for the processes, operations, facilities, applications, taking into account metrics and/or value drivers for greenness and carbon emission. The Green Diagnosis System may utilize the daisy-chain analysis for the heat map analysis and shortfall assessment to identify transformation opportunities in the current environment—infrastructure and organizations shown at 220.

The Green Diagnosis System reuses component representation of an organization and associated processes, keeping track of the environment related parts like provisioning of the consumed energy, possible carbon emission, and the like. Benchmark data for metrics represent the best practice value in the industry. For example, assume the carbon emission of a data center or another facility is 100 ton. If the industry best practice (benchmark data) of such facility is 50 ton, there is the gap, an opportunity to fill it for a green transformation initiative. GTW of the present disclosure automates such analysis using the data prepared at 202. The Green Diagnosis System uses such benchmark data for value drivers or metrics for identifying energy consumption and carbon footprint as the cost drivers and extends the application model to infrastructure to include software applications, server hardware, facility equipment for power and cooling. It applies daisy-chain analysis to identify all the business processes and activities related to a business component and heat map analysis to identify shortfalls and gaps. The Green Diagnosis System may reuse existing analysis tools (CBM map and like) for green-related analysis. The same CBM map for a data center may be reused for another data center in a similar fashion with different as-is values.

At 206, Green Solution Discovery System identifies green value drivers and employs solution search based on the green value drivers to further identify solutions for resolving the identified and/or classified hotspots and shortfalls. The Green Solution Discovery System also utilizes the daisy-chain analysis and one or more solution catalogs to identify green transformation initiatives to address the discovered shortfalls and support the intended business transformation, e.g., as shown at 222. Green performance metrics (value drivers) allow analysis tool to discover and recommend solutions to fill “green” shortfalls in processes, organizations, and infrastructure.

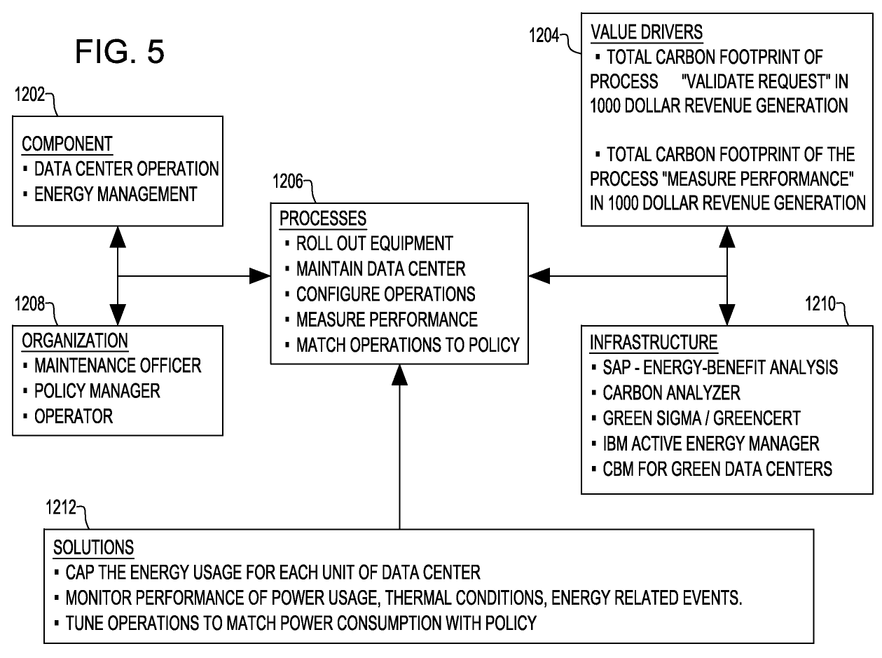

Solutions may be automatically discovered for supporting components associated with a shortfall, for example, by executing the daisy chain queries that correlate solutions, components, and business processes. Green Solution Discovery System may include solutions in the best green practices catalogs and provide methods for the green effective solutions compositions. Green Solution Discovery System utilizes Green performance metrics (value drivers) to discover and recommend solutions to fill “green” shortfalls in processes, organizations, and infrastructures. Examples are shown in FIG. 5.

Daisy-Chain Analyses of the present disclosure allows users to navigate the integrated view of models, for instance, to provide understanding of the direct and indirect relationships of models (inference). Heat map analysis identifies to the users one or more carbon metrics values associated with components. Green shortfall analysis provides application, deployment, and/or organization overlaid on components to visually identify and categorize shortfalls. Green Solution Discovery Analysis identifies one or more solutions found for components with shortfall, and by utilizing semantic technology for inference.

At 208, Carbon Analysis System takes into account green IT models and solution options. Carbon Analysis System outputs the as-is values of the carbon metrics by analyzing the current practice and systems by using the green IT models and carbon metrics. Known carbon analyzer such as IBM GreenCert system 224, carbon analysis model for Supply Chain and/or will be known analyzers may be utilized. An investment analysis system 234 may be implemented and employed alongside the carbon analysis system. Carbon Analysis System combines an operation model with carbon footprints of process, facility, operations, logistics, software, hardware, people model and enables analysis of the model options. The heat map analysis may compare the as-is values output by the Carbon Analysis system to the benchmark data. The Green Business Case Calculator may also use the as-is value output by the Carbon Analysis system in “carbon flow analysis.”

At 210, Green Case Analysis System analyzes the impact of carbon trading. The Green Case Analysis System may utilize IBM's Green Case Calculator (GCC) shown at 226, which may be an MS™ Excel-based tool, with a pre-built template for conducting financial and carbon analysis of the chosen solutions. FIG. 3 illustrates the features of Case Calculator in one embodiment. For each category of solutions, GCC identifies cost and carbon benefits, allows distribution over period (e.g., year) producing a cost-carbon flow up to a predetermined period, for example 25 years from now, and consolidates the overall analysis with financial and carbon metrics. The financial model calculates the standard metrics such as Return on Investment (ROI), Net Present Value (NPV) and Internal Rate of Return (IRR) of the project, and break even period. The carbon model provides ROI (Reduction on Investment) and ICC (Internal Cost of Carbon) of different categories of green solutions. An executive summary 310 represents financial and green results graphically. In 302, the user configures the case analysis for the particular customer in hand. The user will provide basic information about the project, and set up values for basic parameters for analysis such as time period for the analysis and the like. In 304, the user configures the detailed analysis for both finance and carbon analyses. The user will view and configure and adjust processes to be affected by the selected solutions, the metrics and value drivers associated with the processes, their values, e.g., as-is, benchmark, median, and target values. Then the user adjusts the schedule of the project by adjusting the allocation of projected benefits for the defined period of project time. The user provides the cost information of the selected solutions. In 306, the user sees the financial case generated by the tool using the benefit and cost information set up in the previous step 304. The analysis result is a standard financial cash flow analysis showing the values of the standard financial metrics described in this section. In 308, the user sees a carbon benefit analysis in parallel with the finance benefit analysis in 306. Again, in parallel with the standard financial metrics shown in 306, 308 utilizes a set of comparable carbon metrics. In 310, the user sees an executive summary including simple tables and charts that capture the essence of the analysis results shown in 306 and 308, along with some help information.

Referring back to FIG. 2, at 212, Green Solution Prioritization system establishes solution portfolio management system including carbon effective solutions 228. For instance, as described above, GTW analyses enable the discovery of a set of solutions which potentially reduce the gap between the as-is practice and the benchmark practice identifying “pain points”. The information including the metrics information and their benchmark and as-is values is used to provide heat-map, daisy-chain and what-if analysis. Green Case Calculator enables the calculation of benefits (in finance and in carbon) of the solutions individually and/or in combination; so it enables the prioritization of the solutions based on the benefit (in finance and carbon). Based on the prioritized list of potential solutions, the user can construct a project and/or solution portfolio by selecting the appropriate solution to the business and also taking into account the strategic objectives of the organization and its available resource (human, finance, and time). Various solutions may be provided with recommendations to optimize emissions and costs, and the users may choose manually the best ones. Green Solution Prioritization system may also automatically select the best ones based on previous knowledge or expert system methodology. Green Solution Prioritization system can automatically prioritize the solutions to minimize carbon footprint. Revenue optimization system 236 may be implemented alongside the green solution prioritization system. In one aspect, an organization unit or component is measured with both quantitative and qualitative metrics.

At 214, Green Solution Implementation system establishes technical solutions for the enterprises including green IT best practices. Technical green solutions for Green Data Centers 230 may be established by this system. Optimal path to transform the business unit is identified based on carbon-benefit and cash-benefit analysis. The User may be provided with a case report for the transformation path. For instance, technical specifications may be established for implementing the selected or prioritized solutions. Green Solution Implementation system may include working with providers of service to actually implement the changes, for example, cooling, heating, building management, etc.

At 216, carbon monitoring and measurement system monitors the power consumption and carbon emission, for example, continuously, periodically, in real time, or in any combinations thereof, etc. This module can use the same models used by the GTW (component, metrics, process, organization, infrastructure, etc.) along with the benchmark data and the current values read by the system continuously, or in real time, etc. That is, the carbon analysis provided by GTW may be used for both pre-implementation and post-implementation of solutions. Tools such as IBM GreenCert system 232 that analyzes carbon or green gases may be used to monitor also. The output of the carbon monitoring and measurement system, e.g., the monitored power consumption and carbon emission is fed back into the preparation of analysis data at 202.

Green Monitoring and Measurement System measure the metrics that are indicative of Green Performance, for instance, in addition to traditional system and business monitoring. The monitoring includes environment (Green) monitoring which monitors or measures metrics such as heat flow, air flow, power consumption, temperature field, etc. for green emission reporting and green solution decision. Green monitoring uses additional sensors for measurement of power usage by different components and a network for transmitting this information.

Monitoring may also include system level monitoring which monitors the metrics for server utilization, memory usage, network load. The monitoring looks to achieve system health, on-demand capacity planning, load balancing, resource partitioning. The monitoring may also include business level monitoring, which includes monitoring metrics such as application throughput and latency, for instance, to achieve service level agreement (SLA) contract compliance.

Referring back to the data preparation, preparing data at 202 may include preparing various models of data center's operational functions. The models may include a component business model of an organization, a process model, an organizational model, a set of infrastructure equipments, e.g., a list or hierarchy of infrastructure equipment that help implement the operations under investigation, and a set or a list or hierarchy of metrics that help measure the performance of the processes and the activities under them. Preparing data at 202 may also include linking all of those models with one another for helping inference with the daisy-chain analysis. The linking may be performed manually by uses such as consultants or automatically or even yet semi-automatically, i.e., part manually and part automatically.

Component Business Model (CBM) is a method developed by IBM to help analyze an organization or the like from multiple perspectives such as people, process and technology. A CBM provides a component view where the similar activities of a given company's processes are grouped into respective components. A sample component map is represented as a two dimensional matrix: The columns are created after analyzing a company's functions, competencies, and value chain. The rows are defined by actions and their accountability levels. The top row may be categorized as “direct,” representing all those components that set the overall strategy and direction for the organization. The middle row may be categorized as “control,” which represents all the components that translate those plans into actions, in addition to managing the day-to-day operation of those activities. The bottom row may be represented as “execute,” which contains the components that actually execute the detailed activities and plans of an organization. The component map shows activities across lines of organization, without the constrictions of geographies, internal silos or units. The component map for a company is typically represented on a single page. A component may be an abstract element. It is a collection of similar and related activities from various processes. From this point of view, processes can be thought of as flows of activities between and within components. A component is defined by a set of people, processes and technology needed by its function. In the CBM view, an enterprise or organization is a collection of components that are ‘networked’ together.

A component map of data centers, with each component relating to functions or operational phases at each level of accountability may be created, for instance, with input from the data center practitioners. In a service engagement, a user using the green transformation workbench tool of the present disclosure, may collaborate with various teams in the data center operational practice and identify non-overlapping units to ensure the collective completeness of all the functions. Shortfalls in components can then be identified from the consolidated view, providing a high level overview of the data center practice.

A Component Business Model map for data center operations may show, for example, seven organization competencies (presented as columns of CBM) at three level of accountability (presented as rows of CBM), for handling data center functions in its entirety. The competency of the Customer Relationship Management may serve external communications in developing and maintaining data center offering. Organization Management may develop strategies and manages finance, technology, staff and vendors to conduct its functions effectively. Organization Resilience may involve handling unexpected situations and managing risk assuring continuity. Service Performance may aim to monitor and optimize data center services making the performance parameters transparent across the verticals to enable collaboration for required actions. Other competencies may handle lifecycle operations of data centers in developing, deploying and maintaining the services. One may observe the aggregation of these components exhaust the all of the data center functions.

A process model encapsulates or models a process. An organization process is a flow of one or more activities. An organization process when executed accomplishes a specific objective. An organization activity is the lowest level task in an organization process. An organization process in a data center is an operational task to manage, maintain the facility and enable service. At a high level, it involves managing facility, people and technology with various aspects of operational activities assigned. As the details increase, the process may describe the technical task as one of the step in accomplishing respective function. As an example, the process hierarchy in data centers begins with three root processes: manage data center, develop and manage human capital, and manage technology. The operational processes of data centers may be shown in detail, in an expanded tree view. The data is collapsible and expandable as shown.

The initial branch of data center management involves maintaining assets and improving their performance. Assets include IT, power distribution, UPS (uninterruptible power supply), network equipment, HVAC (Heating, Ventilating, and Air Conditioning) and other infrastructure. The scope for optimizing asset usage dwells into every category with multitude of solutions with varying benefits. On the other hand, there are various processes in managing human capital and technology for efficiency. Each component constitutes a collection of organization processes, which communicate to other components to achieve operational completeness.

The data preparation phase or stage at 202 in FIG. 2 also may include identifying one or more performance metrics and benchmarks. Identification of the values for a data center can be tracked from varying levels of detail in technical and operational setting. The associations between value drivers and components are discovered through their relationships with organization processes and activities defined, for example, by a user. One strategy is to track a set of value drivers to respective benchmark values and identify the road map strategies. Since a data center may be considered as an emerging area of research with plethora of opportunities for efficiency, the present disclosure provides flexibility in the model to compute benefits based on the user domain knowledge. This model allows three types of value drivers and performance metrics identified for data center operations: Efficiency and Quality Metrics, Technical Measures, and Reduction Factors. Other types may be included.

Efficiency and Quality Metrics include a generic value driver that captures the performance as the percentage of efficiency which can be improved by a variety of solutions which may be analyzed during a client engagement or test deployment. These metrics may be the standard metrics available and practiced in the industry representing the efficiency levels of facilities such as cooling, power systems, lighting, network, IT system including CPU utilization, and productive proportion of deployed systems.

Technical Measures provide metrics that include physical ones that denote operational status of a data center such as Cooling Power Density and Average UPS load. When the measures are tightly coupled with economic factors, these metrics provide an accurate assessment for greenhouse emissions. These metrics may be also used in the related solutions in identifying target benefits. A user or expert knowledge may be used to provide accurate and realistic information, as the rest of the analysis may be sensitive to the benefit levels identified at this stage.

Reduction Factors refer to those factors that impact data center infrastructure efficiency. The value for these metrics may be computed by matching the present and target values of DCiE (Data Center infrastructure Efficiency) with solutions chosen. Each solution's impact on DCiE is measured by percentage improvement. The impact factors also referred to as reduction factors allow to build a case with minimal details and improve the case incrementally with additional developments. The reduction factor denotes the impact of the performance metric in context of study, for example, DCiE impact by improving CRAC (Computer Room Air Conditioner). Details of DCiE and related factors follow:

DCiE=IT equipment power/Total facility power

Typical DCiE in industry is known to be 0.33. The reverse value of DCiE is known as Power Usage Effectiveness (PUE), and also used as a popular metric:

PUE=1/DCiE

The best practice value of PUE, for example, may be 1.8.

Other metrics may be used, for instance, as developed or utilized by industry practitioners. IT Hardware Power Overhead Multiplier (H-POM) measures how much of the power input to a piece of hardware is wasted in power supply conversion losses or diverted to internal fans, rather than making it to the useful computing components, and is defined as follows:

H-POM=AC hardware load at plug/AC hardware compute load

Deployed Hardware Utilization Ratio (DH-UR) measures the fraction of IT equipment which is not productive, and is defined as follows:

DH-UR=# servers running live applications/total # of servers deployed

Deployed Hardware Utilization Efficiency (DH-UE) measures the opportunity for servers to increase utilization by the virtualization and is defined as follows:

DH-UE=min.# servers to handle peak load/total # of servers deployed

An example practice improves the performance metric, i.e., DCiE (Data Center infrastructure Efficiency) introduced above, by identifying the percentage change in DCiE realized by each solution applied. It may be then used to compute detailed benefits by further case analysis using the GCC tool described above. The value drivers and their structure for data centers may be shown in detail, in a tree view.

Organization models may be another data that is prepared at 202 in FIG. 2. Along with the infrastructure, the organization of a data center (and any other enterprise) supports the operations of its processes and provides an area for transformation including green transformation. Organization models may be obtained, for instance, using expert knowledge at data centers. The organizational structure in a data center (e.g., in areas such as operation and technology) may be shown and expanded in detail in a tree view. The organizational hierarchy in a data center is defined and further mapped to respective business processes.

Along with the organization, the infrastructure of a data center (or any other enterprise or facility) supports the operations of the organization processes and provides an area for transformation including green transformation. Models of infrastructure of data centers supporting the organization processes may be obtained, for instance, using expert knowledge at data centers or enterprises. The infrastructure structure in a data center in service areas and details of the service areas may be shown and expanded in a tree view. Infrastructure includes software, IT hardware and facility equipment in a data center. One or more or combination of these items perform different service operations such as Analysis, Infrastructure Equipment (Compute Service), Integration, Measurement, and Server Efficiency.

Data preparation stage shown at 202 in FIG. 2 may also include gathering a catalog of solutions that may be applied to address shortfalls in the current organizations and infrastructure of data centers identified by using the CBM-based qualitative analysis. Examples of such shortfalls include poor demand and capacity planning within and across functions (IT, facilities), significant failures in asset management (e.g., 6% average server utilization, 56% facility utilization). Other examples of shortfalls may include not using computer virtualization aggressively enough, lack of using commissioning, etc.

The solution can be a combination of one or more of hardware, software, and services, turn-key solutions, shrink-wrapped solutions. Downstream technical solutions such as using such services as Web services on SOA meeting, etc. may be included for given requirements for green transformation. Also, solutions suggested by GTW can be consulting services in the process transformation or organization strategy area. Details of each of the example catalog may be shown in a tree view. Solutions listed provide for improvement in infrastructure and operations that align with people and processes. The primary drivers of poor efficiency may include, but are not limited to: Poor demand and capacity planning within and across functions (business, IT, facilities); Significant failings in asset management (6% average server utilization, 56% facility utilization); Boards, CEOs, and CFOs are not holding CIOs accountable for critical data center facilities, CapEx and data center operational efficiency. Capital expenditures (CAPEX or capex) are expenditures creating future benefits. Capex are used by a company to acquire or upgrade physical assets such as equipment, property, or industrial buildings.

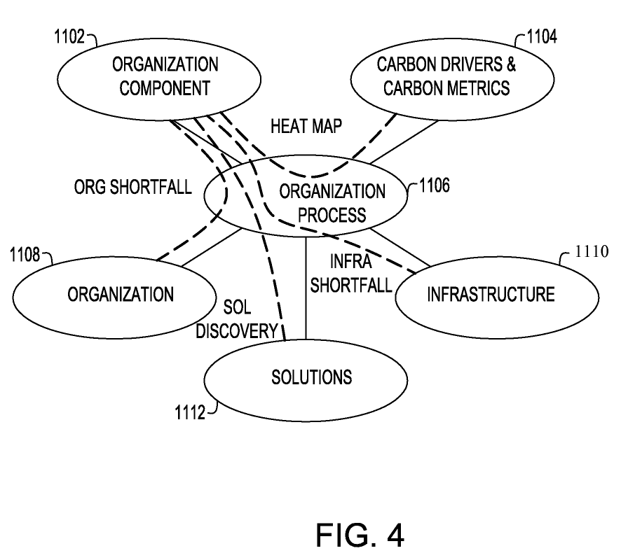

The data preparation phase at 202 in FIG. 2 also includes linking those models. The models described above are mapped to each other. This linking of models and the ability to query them is referred to as “daisy-chain analysis” in the present disclosure. With the daisy-chain of models, the user can see all the processes and activities that are associated with a component. In turn, the user can see all the metrics (along with their values) and value drivers of the selected organization processes, and so the user can qualitatively see the overall performance of the component. FIG. 4 illustrates daisy-chain of models. For the above-described six base models (Organization Component 1102, Carbon Drivers and Carbon Metrics 1104, Organization Process 1106, Organization 1108, Infrastructure 1110, Solutions 1112), the user can provide a set of initial model association to organization processes as part of the data preparation. For example, there may be five types of links, shown in solid lines. In this example of model linking, a hub-and-spoke approach is used to link the models, i.e., all models are linked to the Organization process model rather than each model linking to each other model.

FIG. 5 illustrates an example of a data model that includes daisy chain of data. Daisy-Chain analysis allows navigation across the integrated view of models to understand the direct and indirect relationships of models (inference). Component model 1202 may include components related to data center operation and energy management. Value drivers 1204 in this data model may include DCiF data. Processes 1206 in this data model may include processes that roll out equipment, maintain data center, configure operations, measure performance, match operations to policy. Organizations in this data model may include maintenance officer, policy manger, and/or operator. Infrastructure 1210 in this data model may include energy benefit analyzer, carbon analyzer, Green Sigma/GreenCert, Active Energy Manager, CBM for Green Data Center. Solutions 1212 in this data model may include capping the energy usage for each unit of data center, monitoring performance of power usage, thermal conditions and energy related events, tuning operations to match power consumption with policy. Heat map is generated by comparing value drivers (metrics) associated with components. Green shortfall analysis allows application and/or deployment and/or organization overlaid on components to visually identify and categorize shortfalls. Solution discovery system provides the solutions for components with shortfall.

In one embodiment, all the data, for example, both base model data and the association data, for example, is collected in a single place, for instance, in a spreadsheet file such as the MS Excel™ file with a specific but flexible format. Such spreadsheet file or like is referred to as Model Template. A Model Template includes the data in a selected format, for instance, readable by the GTW. Once all the necessary data is prepared in the Model Template, the user is ready to conduct the green transformation analyses on the data center's operational functions.

The Green Transformation Diagnosis System (e.g., 120 in FIG. 1) utilizes the Component Business Model-based transformation methodology that represents enterprises in a consolidated view, grouping together similar activities as a component and classifying functionality into non-overlapping components. It utilizes the daisy-chain analysis for the heat map analysis and shortfall assessment to identify transformation opportunities in the current environment, i.e., infrastructure and organizations.

The heat map analysis is a capability of CBM where the user discovers one or more “hot” components that are associated with one or more strategies and/or pain points. The heat map analysis in CBM measures the “temperature “of each component—by comparing the as-is values of relevant metrics associated with each component against the industry benchmark and/or median values of the metrics. If the as-is values of metrics associated with a component is not as good as the industry median values, that component has a temperature and is called a “hot” component. Determining reasons for the temperature is high is also referred to as discovering or determining “pain point.” In the traditional CBM analysis, this step was conducted manually by a user relying on his/her knowledge and expertise in the domain. The green transformation methodology of the present disclosure automates the capability as visual queries, by taking metrics values into account with the analysis. The methodology of the present disclosure allows the user to explore a value driver tree that includes a hierarchical view of a plurality of value drivers to identify one or more value drivers that may be associated with a certain organization strategy and/or pain point. In one embodiment, the basic mapping or association of value drivers to organization processes and that of organization processes to component may be done manually during the “data preparation” phase of the analysis. Then the value drivers associated with the components may be inferred by the system by using the transitive relationships—this is referred to as the “daisy-chain analysis”, and utilizes the “semantic technology”. The system infers the indirect relationship and shows it in the visual rendering of models in software, which are utilized in plain browsing, heat map analysis, shortfall assessment, and solution discovery, as shown in FIG. 4. The discovery of “hot” components that affect the organization strategy can be accomplished. Then the methodology includes coloring (or using other visual effects) the identified hot components differently to distinguish ones that affect positively or negatively to the strategy. The methodology automatically compares the industry benchmark and the as-is value of the operational metrics and performance indicators associated with the components to decide on their color based on one or more predetermined thresholds.

For example, the reduction metrics associated with the data center operational processes are compared with the industry benchmark levels obtained, for instance, by surveying. The organization components whose metrics underperform in comparison to the industry benchmark values may be highlighted in yellow. The components whose metrics underperform in comparison to the industry average values may be colored in red. The components whose metrics perform above the industry benchmark values may be highlighted in green. Other colors or other visual effects may be utilized. A heat map may be generated for ABC Inc., and this green performance analysis may indicate that the metrics associated with performance tuning function of ABC Inc. underperformed by 30% in comparison with the industry's best practice and by 15% in comparison with industry's median.

The Shortfall Assessment allows the user to map the existing infrastructure or organization structure of a data center against the “hot” components identified in the heat map Analysis. In this step, the infrastructure or organization structure that implement the organization processes associated with the underperforming functional areas may be examined in detail. This assessment helps understand how the current infrastructure or organization structure, such as applications, network capabilities or certain departments, supports the organization components, especially, for those hot components. The analysis may include collecting the information on the current infrastructure or organization structure. Then the mapping of IT applications or organization structure to the components becomes, again, an execution of a simple data query to the basic model mapping. The system infers the indirect relationship and shows it in the visual rendering of models in software, which are utilized in plain browsing, heat map analysis, shortfall assessment, and solution discovery, as shown in FIG. 4. The user does not have to write the query in text; all the queries may be visual queries in this system—the user only needs to click buttons or check boxes to execute the query. An equivalent of a query written in English, for example, for an organization shortfall assessment, may be “visually overlay icons of selected department on top of visual rendering of components, so the user can see which department supports which component.” With the system and method of the present disclosure, the user can visually discover, and categorize shortfalls such as gap, deficiency, duplication and over-extension.

The green transformation methodology of the present disclosure visualizes the mapping on the CBM map by overlaying infrastructure items and/or organization structure on components. Then, the user can visually classify possible infrastructure shortfalls into several types. Typically, four types of opportunities tend to arise. A gap indicates that a hot component does not have any infrastructure/organizational support. The enterprise may want to consider an infrastructure/organizational investment to improve the component's performance and support the intended transformation. A duplication indicates that a component is supported by multiple infrastructure items or multiple departments, possibly, deployed over time. The organization may want to consolidate the applications to improve performance and reduce cost in communication and maintenance overhead. A deficiency indicates that the current application lacks key functionality, or is poorly designed, and so incurs a project opportunity. An over-extension indicates that a system designed to support one component is extended beyond its core capability to support others. Different definitions for the shortfall types may apply.

The shortfall assessment is facilitated by an innovative visual overlay of information on organization components. An infrastructure overlay may show which infrastructure items implement the functions of which organization components. For example, the triangles may represent the infrastructure items and may be color-coded with tool-tip showing the name of the item. For example, the user may visually notice that six infrastructure items are supporting the ‘Performance Tuning’ component in ABC Inc., such as:
(a) CiRBA Solution
(b) Ecos Consulting and EPRI's Power Applications Center
(c) Energy Efficiency Rating
(d) IBM System Storage
(e) IBM Virtualization
(f) IBM Virtualization Engine TS7530 Server

The user can tell based on system performance that the low level of virtualization was implemented. This fact highlights an opportunity for virtualization. The user then can mark the Performance Tuning component having ‘deficiency’ in infrastructure. This component is marked as a candidate for ‘deficiency’ shortfall. The noted shortfall is shown as ‘DF^{inf}’ (for deficiency in infrastructure) to denote infrastructure shortfall on the Performance Tuning component. The user can see that there are six infrastructure items (colored triangles) supporting this component, “Performance Tuning.” The user also can see that the performance of the component is NOT good by its color (red, not green or even yellow)—that is, it is a “hot” component. These two facts combined implies that the performance and capability of the six infrastructure items are not good enough, i.e., “deficient.”

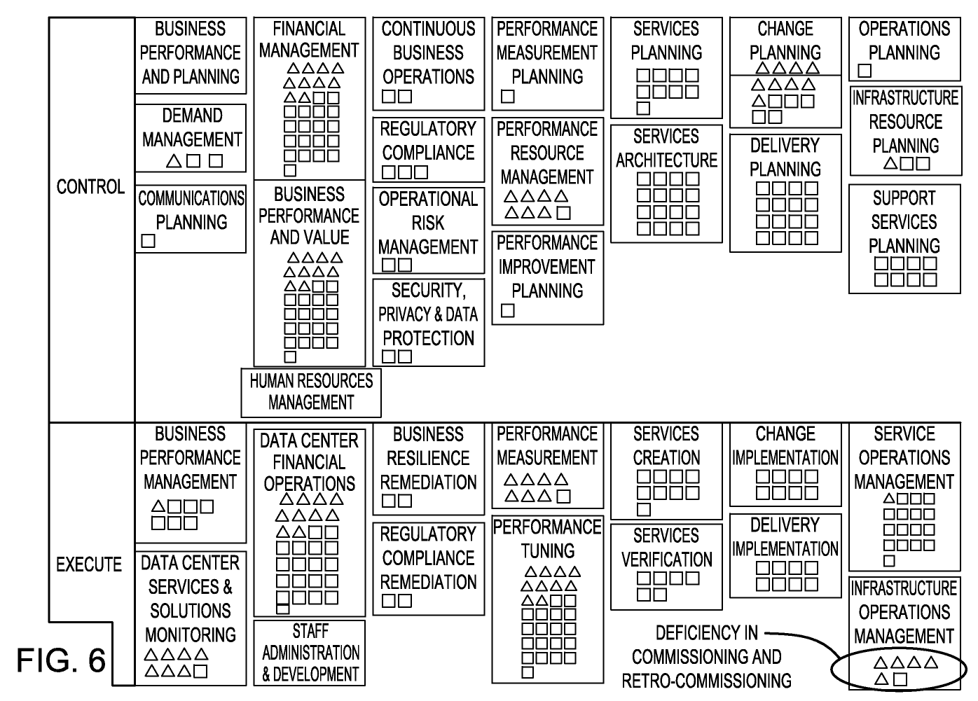

FIG. 6 shows which organizations implement the functions of which components. The squares represent the organizations and color-coded for different organizations. The user visually discover deficit in commissioning and retro commissioning in ‘Infrastructure Operations Management’ component. This fact highlights an opportunity for consolidation. The noted shortfall is shown as “DF^{org}” (for deficiency in organization) to denote organization shortfall on the ‘Infrastructure Operations Management’ component. Similarly, the user may see that there is a department (navy square on top of the component) supporting this component, “Infrastructure Operations Management.” The user also sees that the performance of the component is not good—it is another “hot” component. The user can conclude that the capability and/or performance of the department is not good enough, i.e., deficient. So there is deficiency shortfall in organization.

In solution discovery stage, once infrastructural and/or organizational shortfalls are identified and classified, one or more solution catalogs are used to identify transformation initiatives to address the shortfalls and support the intended transformation. The methodology of the present disclosure allows the user to explore the solution space to identify one or more solutions that may address one or more shortfalls of interest. The discovery of solutions for supporting components associated with a shortfall can be automatically conducted by executing the “Daisy-Chain” queries that correlate solutions and components by using their relationships to organization processes. In addition, the methodology of the present disclosure may allow the user to manually correlate them, if desired.

The choice of solutions depends on a number of factors such as breadth of the pain points, the benefits offered by a solution, client's budget constraints, duration within which improved results are expected, etc. In this example, the solutions of ‘Server Virtualization’ and ‘Commissioning and retro commissioning’ were discovered to address the infrastructure and organizational shortfalls, respectively. Therefore, the user has chosen the solutions as potential candidate solutions for improving the ‘Performance Tuning’ and ‘Infrastructure Operations Management’ of ABC Inc. The discovered solutions are green solutions. That is, they are for improving the green metrics values. For example, the virtualization consolidates multiple small servers into a one big iron, reducing the energy consumption and indirectly reducing the carbon emission.

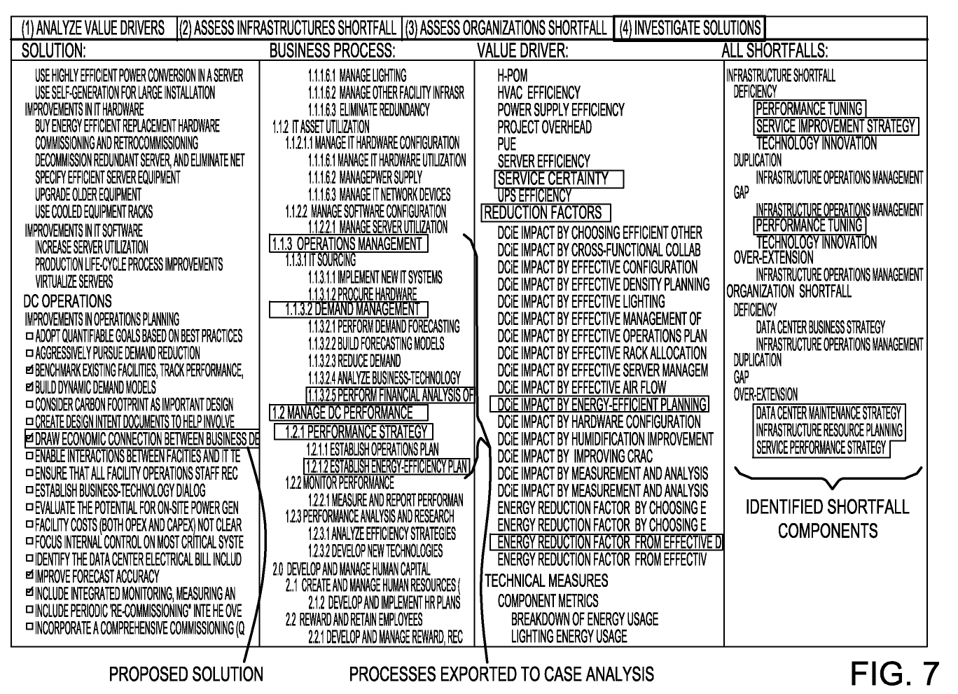

FIG. 7 shows the model linkages, which lead to the selection of the solutions by using the daisy-chain analysis. Selecting a proposed solution or a set of proposed solutions shows the linkages of that solution with process, metrics and shortfalls. These linkages help users to understand, for example:
(a) which processes the selected solution impacts (e.g., positively),
(b) which metrics can be used to measure the impact of process improvements to be achievable by implementing the chosen solution, and
(c) with which marked shortfalls the chosen solution will help.

The solution analysis helps the user get a quick idea at a qualitative level about which solutions can help address shortfalls. The next step is to analyze the potential benefits obtained by implementing the chosen solution(s) quantitatively. Users can select to perform this case analysis, for example, by clicking a corresponding functional button on a user interface in a framework that implements the methodology of the present disclosure. Using the above-described methodology, the user can identify opportunities for green transformation.

FIG. 7 shows a panel with different aspects such as the discovered shortfalls, value drivers, processes, and solutions. This panel may provide an interactive analysis interface for the user. The user clicks on an entry in each aspect (e.g., a shortfall in the shortfall tree) and the system shows all the entries in other aspects related to the selected shortfall. The user will understand what shortfalls are out there, and what solutions are available for addressing the shortfalls through their relationships to processes and metrics. Eventually, the user may select zero or more solutions for each shortfalls identified. Such sessions for investigation and selection may happen multiple times until the user collects a set of solution, which then may be used for green case analysis.

The next step is to evaluate the recommended solutions to build cases. The evaluation should accurately model the potential benefits that can be achieved by implementing the recommended solutions while, at the same time, considering the costs and investments involved. In this disclosure a Green Case Calculator (GCC) tool is provided to perform the cost and benefit analysis. The GCC tool standardizes the key input and output of a typical case, and yet, allows flexibility for users to modify and add benefits and reports, making it easier to customize the application for the needs of a particular project. GCC tool may be selected by clicking on a corresponding functional button in the user interface of GTW of the present disclosure. As an example, a Green Case Calculator spreadsheet opens up with an ‘Analysis Scope’ tab in focus.

The table in Analysis Scope 1802 has two columns: ‘Solution Name’ and ‘Process Name’. The ‘Solution Name’ column refers to the name of the solutions that were chosen for analysis from the previous steps. The ‘Process Name’ column refers to the corresponding organization processes that will be impacted as a result of improvements through the chosen solutions.

Before starting the impact analysis of the selected solutions on the bottom line, input data is received to perform the analysis. The Green Case Calculator guides the user to provide the types of input data it needs in a structured way through several worksheets which provide templates for the data. For example, the Home page may instruct the user to provide the project time frame and configuration for the analysis along with the basic company information.

Additionally, GCC uses data related to the annual revenues and energy consumption of the company to provide a base line profit and emission level for the analysis. There are various sources for carbon emission and they may be categorized as follows: direct sources (on-site combustion of fuels, e.g., boilers, business travel, company-owned vehicles) vs. indirect sources (off-site combustion of fuels (for use on-site), e.g., procured resources: electricity, materials and employee commute), process sources (on-site emission caused by processes) vs. energy export sources (on-site combustion of fuels for use off-site), and upstream sources (emissions caused by suppliers) vs. downstream sources (emissions created by an organization's products/activities during their lifecycle). As an example, the carbon emissions related to the energy consumption are explained below and explanation focuses on finding opportunities for energy efficiency that reduce equivalent emissions. GCC collects the base line data for the energy consumption. It should be understood, however, that the methodology of the present disclosure does not limit the green transformation only to carbon or other greenhouse gas emissions related to energy consumption.

Another input data GCC uses may include various technical metrics that are related to the key performance metrics discussed above. GCC may utilize a simple Total Cost Ownership (TCO) model of the data center to instruct the user to provide this data. This data collection computes the base line performance of DCiE of the data center, which is affected by selected set of solutions. The TOC model of the data center may include several categories as follows.

Hardware: This category computes the total annual electricity usage and energy costs, by taking into account the factors such as the number of IT hardware systems filled per rack, % of racks filled, % of racks in live service, % min of a rack to enable service, % compute utilization per rack; energy consumption of hardware, cooling and auxiliaries.

Electricity: This category computes total annual electricity usage and energy costs by taking into account the factors such as electricity price and indirect costs, energy distribution over IT and facility, loss factors for IT, cooling and auxiliaries.

Floor Usage: This category computes the total annual floor usage by taking into account the factors such as land costs, floor distribution for IT and facility.

Market: This category captures market interest rate, carbon emissions equivalent for energy, market price of carbon credit (CER), other miscellaneous costs; personnel costs for IT, Facilities, Maintenance and Security.

Financial: This category computes the total annualized costs with various distributions by taking into account the factors such as capital costs of IT and facility infrastructure and consolidates operating costs.

This information may be enhanced to capture more technical details to identify TCO in future so that a concrete benefit modeling can be done.

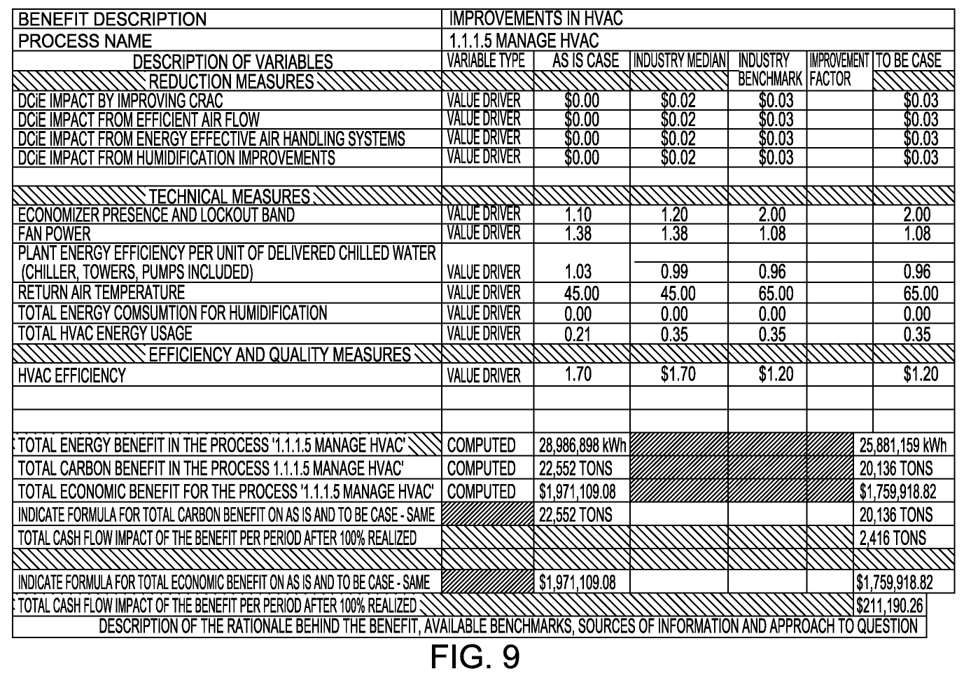

Once all the input data is in place, the user can work on GCC to conduct a case analysis, which may comprise a few steps. This disclosure presents herein the computation of financial and carbon benefits of a particular solution, i.e., the implementation of the ‘Virtualize Servers’ solution, at ABC Inc. As an example, the ‘Performance Tuning’ component includes the process called Manage Software Configuration. This process is passed down to GCC for the benefit computation. The GCC tool automatically configures itself to capture the preliminary benefits for the process. Also, this configuration is done by making a simple assumption that, if the performance metrics are below the benchmark, then implementing the industry best-practice solution would improve the metrics to the benchmark values. Therefore, the absolute difference between the as-is values for the metrics for each of these processes and the benchmark values gives the expected savings in cost and carbon emission. A view of the benefit modeling is shown in FIG. 9. It shows the organization process that will be impacted by the implementation of the solution along with the performance metrics and their values.

Once the total cost and carbon benefits are computed, they may be amortized over the period of financial analysis automatically by the GCC tool. The user can distribute the cost and carbon benefit realization independently over the analysis period. Additionally, the user can define the benefit category of the particular solution for consolidated analysis. A snapshot of a benefit scenario may be shown where the benefit is amortized over three years. The table may show the benefit to a process when a solution is implemented.

Before a case analysis based on the benefit calculation is created, GCC requests the user to the define investment cost in different areas. Also, GCC allows the user to tag the investments with categories to facilitate the consolidated analysis. A view of the cost modeling in GCC may be shown. As an example, a table may show the cost/investment of the selected solutions, e.g., categorized over a period of years, and their aggregation, plus maintenance of the deployed solutions.

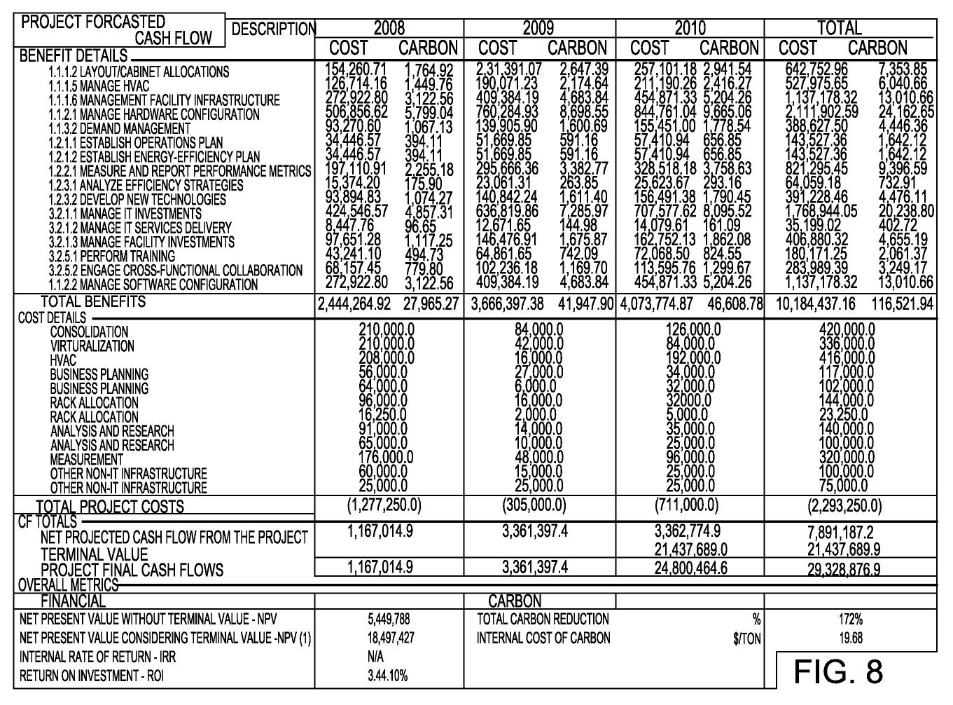

Once the costs and other specific data are provided as input to the GCC tool, it automatically computes the key financial and carbon metrics, and presents an executive summary with charts. An example financial analysis result is shown in FIG. 8. It is a consolidated analysis showing both financial and carbon benefits. Based on the benefit and cost calculated in the previous two tables, this table put them together side by side to show the cost-benefit analysis or the cash flow and/or carbon flow for the standard financial analysis and carbon analysis. The benefits are described by the processes that will be affected by the deployed solutions, over three years, for both cash and carbon. The cost is described by the solution category over three years, and by cash. It also shows the aggregation—Cash Flow Totals, Financial summary and Carbon summary.

The financial benefits are represented by using standard cash flow metrics such as Net present value (NPV), Internal Rate of Return (IRR), Return On Investment (ROI), and Payback period. Net present value (NPV) is a standard method for the financial appraisal of long-term projects. It measures the excess or shortfall of cash flows, in present value (PV) terms, once financing charges are met. NPV is formally defined as present value of net cash flows when each cash inflow/outflow is discounted back to its PV:

$$N P V = {\sum }_{t = 0}^{n} \frac{{C}_{t}}{{( 1 + r )}^{t}}$$

Where t is the time of the cash flow, n is the total time of the project, r is the discount rate, and Ct is the net cash flow (the amount of cash) at time t. NPV is an indicator of how much value an investment or project adds to the value of the company. With a particular project, if Ct is a positive value, the project is in the status of discounted cash inflow in the time of t. If Ct is a negative value, the project is in the status of discounted cash outflow in the time of t. Generally, companies will accept appropriately risked projects with a positive NPV.

Internal Rate of Return (IRR) is a finance metric used to decide whether investments should be made. It is an indicator of the efficiency of an investment (as opposed to NPV, which indicates value or magnitude). IRR is the annualized effective compounded return rate which can be earned on the invested capital, i.e., the yield on the investment. A project is a good investment proposition if its IRR is greater than the rate of return that could be earned by alternative investments (investing in other projects, buying bonds, even putting the money in a bank account). Thus, IRR should be compared to an alternative cost of capital including an appropriate risk premium. In general, if IRR is greater than the project's cost of capital, or hurdle rate, the project will add value for the company.

Return On Investment (ROI) or Rate Of Return (ROR) is the ratio of money gained or lost on an investment relative to the amount of money invested. ROI is usually given as a percent rather than decimal value. ROI does not indicate how long an investment is held. However, ROI is most often stated as an annual or annualized rate of return, and it is most often stated for a calendar or fiscal year.

Payback period refers to the period of time required for the return on an investment to repay the sum of the original investment. It is intuitively the measure that describes how long something takes to pay for itself: shorter payback periods are obviously preferable to longer payback periods (all else being equal). Payback period is widely used due to its ease of use.

GCC counters the financial metrics by introducing a number of carbon metrics for “carbon flow” analysis. Carbon Reduction On Investment (CROI) is the % reduction in carbon emissions from all the investments considered for analysis. CROI is usually given as a percentage rather than a decimal value. CROI does not indicate how long an investment is held. However, CROI is most often stated as an annual or annualized rate of return, and it is most often stated for a calendar or fiscal year.

Internal Cost of Carbon (ICC) is a carbon metric useful to decide whether they should make an investment. It is an indicator of the efficiency of an investment (as opposed to CROI, which indicates the value or magnitude), which is comparable to market price of carbon credit (CER). ICC is the ratio of total cost of a green investment to the total carbon emission reduction predicted over the analysis period. A project is a good investment proposition if its ICC is lesser than the market price of carbon that could be earned by purchasing Certified Emission Credits (CER), Thus, ICC should be compared to the CER value including an appropriate risk premium. In general, if the market value of emissions reduced from an investment is lesser than the project's cost of capital, the project will add value for the company.

In the cash and carbon flow forecast in the consolidated financial and carbon analysis shown below in FIG. 8, the result indicates that the project will yield a significant cost and carbon reduction. The Return on Investment (ROI) is projected as over 300% and the Carbon Reduction on Investments (CROI) is more than 150%. Note that the Internal Cost of Carbon (ICC) is below $20 compared to the market price of $21. Over next three years, this denotes that going green by the internal investments is cheaper than buying Carbon Credits for emissions compliance and it brings significant cost savings as well.

GCC generates executive summary reports out of the consolidated financial and carbon analysis results. In further embodiments, reports on the financial benefits may be shown graphically showing the results in the total benefits, costs, NPV, ROI, IRR, costs by category, and breakeven point. An executive summary table may show the financial metrics values. Various charts may show the benefit line and cost line over the period of years, and the cost and benefit by solution category, for example.

Reports on the financial benefits may show graphically the results in the emission reduction tons/year, Internal Cost of Carbon, and Carbon Reduction on Investment. The charts may show the carbon reduction by solution in different charts forms, e.g., bar and pie and the like. Another chart may show the cost effectiveness for the solution in terms of dollar per ton. As in most of other work in the green aspect of data centers, this disclosure used the energy consumption (in kWh) as a carbon emission (in CO2) equivalent. One way to extend the study would be directly considering sources of energy such as hydro, gas, clean energy, etc. EPA provides a guideline for conversion between energy consumption and carbon emission. When the sources of energy are considered, the emission equivalent often varies significantly, and so does the entire carbon flow analysis. The system and method of the present disclosure may apply to carbon emission or other greenhouse gas emission from sources other than energy consumption. Also, the present disclosure provides a set of value drivers with carbon emission at an operational level from the sources stated earlier. An extended and concrete model for data center carbon emission may include both computation of carbon emission and a benefit model coupled with low-level technical metrics from the value drivers presented with hardware, electricity, floor usage, market and financial data.

The Green Transformation methodology of the present disclosure in one aspect provides a tool for the users for identifying and analyzing green transformation opportunities. In one aspect, it embodies structured analytical models (both qualitative and quantitative). The tool helps visualize the linkages of various enterprise models such as the business component model (CBM), the organization process model, the value driver model, the organization model, the infrastructure model, and the solution model. Using this tool, the user can examine which organizational and/or operational functions and components are underperforming in comparison to industry benchmark measures and why. By investigating the organizational responsibilities and infrastructure portfolio in conjunction with organization components, shortfalls such as duplications, over-extensions, gaps and deficiencies can be identified and reasoned. Specific solutions can be discovered to address the identified shortfalls. Financial and Carbon benefits of implementing specific solutions can be analyzed further via conducting a green case analysis.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method for identifying green transformation initiatives for an organization, comprising:
receiving data for analysis, the data including at least one or more industry practice values associated with metrics for determining pollutions from greenhouse gases and organization's values associated with the metrics;
identifying by a processor one or more components in the organization producing the organization's values that are worse than the industry practice values at least based on the received data for analysis;
discovering one or more transformation initiatives for transforming the identified one or more components to at least meet the industry practice values;
determining benefits associated with the one or more transformation initiatives, the steps of identifying, discovering and determining being performed using a component business model; and
transforming the one or more components by implementing the one or more transformation initiatives.

2. The method of claim 1, wherein the metrics includes at least power consumption and carbon emission.

3. The method of claim 2, further including:
monitoring power consumption and carbon emission of the organization; and
repeating the steps of identifying, discovering and determining, using values associated with the monitored power consumption and carbon emission.

4. The method of claim 3, further including performing a daisy-chain analysis for identifying the one or more components and discovering the one or more transformation initiatives.

5. The method of claim 1, wherein the steps of identifying and discovering are performed by conducting qualitative analysis on a business component model that maps data associated with organization's components, processes, activities, infrastructure, organization structure, and one or more initiatives.

6. The method of claim 1, wherein the step of determining the benefits includes performing cost and benefit analysis associated with implementing the identified one or more transformation initiatives.

7. The method of claim 6, wherein the step of determining the benefits is performed using a business case calculator analysis tool.

8. The method of claim 1, further including:
prioritizing the discovered one or more transformation initiatives.

9. A system for identifying green transformation initiatives for an organization, comprising:
a green diagnosis processing module operable to receive data for analysis, the data including at least one or more industry practice values associated with metrics for determining pollutions from greenhouse gases and organization's values associated with the metrics, the green diagnosis processing module further operable to identify one or more components in the organization producing the organization's values that are worse than the industry practice values at least based on the received data for analysis;
a green solution discovery processing module operable to discover one or more transformation initiatives for transforming the identified one or more components to at least meet the industry practice values; and
a green cases analysis module operable to perform carbon benefit and cost analysis associated with the discovered one or more transformation initiatives.

10. The system of claim 9, wherein the green diagnosis module and the green solution discovery module use one or more business component models and performs daisy-chain analysis for identifying the one or more underperforming components and one or more transformation initiatives.

11. The system of claim 10, wherein at least the green diagnosis module and the green solution discovery module are provided as a framework wherein the one or more business component models, the daisy-chain analysis, and the identifying of the one or more underperforming components and one or more transformation initiatives are presented to the user in a consolidated user interface view.

12. The system of claim 9, further including:
an input model template for storing the metrics for determining pollutions from greenhouse gases, the metrics including one or more attributes associated with at least carbon footprint and energy consumption, and data corresponding to the one or more metrics.

13. The system of claim 12, wherein the input model template further stores one or more operational metrics associated with IT applications, deployment architecture, organizational structure, and organization processes.

14. The system of claim 9, further including:
a carbon monitoring and measurement module operable to monitor and measure data corresponding to the metrics.

15. The system of claim 14, wherein the monitored and measured data corresponding to the one or more metrics are used by the green diagnosis module to identify the one or more components that are underperforming.

16. A program storage device readable by a machine, tangibly embodying a program of instructions executable by the machine to perform a method of identifying green transformation initiatives for an organization, comprising:
receiving data for analysis, the data including at least one or more industry practice values associated with metrics for determining pollutions from greenhouse gases and organization's values associated with the metrics;
identifying by a processor one or more components in the organization producing the organization's values that are worse than the industry practice values at least based on the received data for analysis;
discovering one or more transformation initiatives for transforming the identified one or more components to at least meet the industry practice values;
determining benefits associated with the one or more transformation initiatives, the steps of identifying, discovering and determining being performed using a component business model; and
transforming the one or more components by implementing the one or more transformation initiatives.

17. The program storage device of claim 16, wherein the metrics includes at least power consumption and carbon emission.

18. The program storage device of claim 17, further including:
monitoring power consumption and carbon emission of the organization; and
repeating the steps of identifying, discovering and determining, using values associated with the monitored power consumption and carbon emission.

19. The program storage device of claim 18, further including performing a daisy-chain analysis for identifying the one or more components and discovering the one or more transformation initiatives.

20. The program storage device of claim 16, wherein the steps of identifying and discovering are performed by conducting qualitative analysis on a business component model that maps data associated with organization's components, processes, activities, infrastructure, organization structure, and one or more initiatives.
